(19) United States
(12) Patent Application Publication
(10) Pub. No.: US 2025/0166465 A1
(43) Pub. Date: May 22, 2025

(54) GAMING SYSTEMS AND OPERATIONS INCLUDING WALKING SYMBOLS WITH PERSISTENT FEATURES

(71) Applicant: Aristocrat Technologies, Inc., Las Vegas, NV (US)

(72) Inventors: Erick Ching, Cedar Park, TX (US); Rogelio Decasa, JR., Renton, WA (US); Nicholas Farina, Granger, IN (US); Scott Hopkins, Austin, TX (US); Ginette McKay, Austin, TX (US); Jennifer Mizzi, Ewa Beach, HI (US); Steven Richardson, Round Rock, TX (US); Nathan Warms, Austin, TX (US); Deanna Hickox, Georgetown, TX (US); Kelly Lockheed, Elkridge, MD (US); Zachary Smith, Austin, TX (US)

(21) Appl. No.: 18/949,643

(22) Filed: Nov. 15, 2024

Related U.S. Application Data
(60) Provisional application No. 63/601,811, filed on Nov. 22, 2023.

(51) Int. Cl. G07F 17/32; G07F 17/34

(52) U.S. Cl. CPC G07F 17/3267; G07F 17/3213; G07F 17/34

(57) ABSTRACT

An electronic gaming system includes a memory device and a processor configured to cause display of a plurality of symbol positions arranged in a game matrix with a first set of symbols including a first designated persistence symbol displayed in a first symbol position of a first column and a second designated persistence symbol displayed in a first symbol position of a second column. In response to the first designated persistence symbol being displayed in the first column, the first designated persistence symbol is locked in the first symbol position of the first column for subsequent spins of the bonus game. In response to the second designated persistence symbol being displayed in the second column, the second designated persistence symbol is moved horizontally from the second column to an adjacent column of the plurality of columns for a second spin of the bonus game.

### CROSS-REFERENCE TO RELATED APPLICATIONS

This application claims priority to U.S. Provisional Patent Application No. 63/601,811, filed Nov. 22, 2023, the entire contents of which are incorporated by reference herein.

### TECHNICAL FIELD

The field of disclosure relates generally to electronic gaming devices, and more specifically, to gaming systems, methods, and operations that include designated walking symbols that become persistent for a period of game play when those symbols reach a designated location on a game matrix and aggregate when more than one designated walking symbol reaches a symbol location during the period of game play.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system includes a memory device storing instructions and a processor configured to execute the instructions stored in the memory device, which, when executed, cause the processor to cause display of a plurality of symbol positions arranged in a plurality of columns and a plurality of rows defining a game matrix and cause display, for a first spin of a bonus game, of a first set of symbols each within the plurality of symbol positions including a first designated persistence symbol displayed in a first symbol position of a first column of the plurality of columns and a second designated persistence symbol displayed in a first symbol position of a second column of the plurality of columns. In response to the first designated persistence symbol being displayed in the first column, the processor locks the first designated persistence symbol in the first symbol position of the first column for at least one or more subsequent spins of the bonus game. In response to the second designated persistence symbol being displayed in the second column, the processor moves the second designated persistence symbol horizontally from the second column to an adjacent column of the plurality of columns for a second spin of the bonus game.

In another aspect, a non-transitory computer-readable storage medium with instructions stored thereon that, in response to execution by at least one processor, cause the at least one processor to cause display of a plurality of symbol positions arranged in a plurality of columns and a plurality of rows defining a game matrix and cause display, for a first spin of a bonus game, of a first set of symbols each within the plurality of symbol positions including a first designated persistence symbol displayed in a first symbol position of a first column of the plurality of columns and a second designated persistence symbol displayed in a first symbol position of a second column of the plurality of columns. In response to the first designated persistence symbol being displayed in the first column, the processor locks the first designated persistence symbol in the first symbol position of the first column for at least one or more subsequent spins of the bonus game. In response to the second designated persistence symbol being displayed in the second column, the processor moves the second designated persistence symbol horizontally from the second column to an adjacent column of the plurality of columns for a second spin of the bonus game.

In yet another embodiment, an electronic gaming device is provided. The gaming device includes a display device, a memory device storing instructions, and a game controller comprising a processor configured to execute the instructions stored in the memory device, which, when executed, cause the game controller to cause the display device to display of a plurality of symbol positions arranged in a plurality of columns and a plurality of rows defining a game matrix and cause the display device to display, for a first spin of a bonus game, a first set of symbols each within the plurality of symbol positions including a first designated persistence symbol displayed in a first symbol position of a first column of the plurality of columns and a second designated persistence symbol displayed in a first symbol position of a second column of the plurality of columns. In response to the first designated persistence symbol being displayed in the first column, the first designated persistence symbol is locked in the first symbol position of the first column for at least one or more subsequent spins of the bonus game. In response to the second designated persistence symbol being displayed in the second column, the second designated persistence symbol is moved horizontally on the display device from the second column to an adjacent column of the plurality of columns for a second spin of the bonus game.

### BRIEF DESCRIPTION OF THE DRAWINGS

FIG. 1 is an exemplary diagram showing several electronic gaming devices networked with various gaming related servers.

FIG. 2A is a block diagram showing various functional elements of an exemplary electronic gaming device.

FIG. 2B depicts a casino gaming environment according to one example.

FIG. 2C is a diagram that shows examples of components of a system for providing online gaming according to some aspects of the present disclosure.

FIG. 3 is a block diagram showing an implementation of a game processing architecture algorithm that implements a game processing pipeline for the play of a game in accordance with various implementations described herein.

FIGS. 4A-4L are exemplary screenshots or user interfaces of an electronic gaming device programmed to merge, move, and multiply displayed Walking Wild symbols thereon in accordance with certain embodiments of the present disclosure.

FIG. 5 illustrates an exemplary flow-chart of method operations performed by an electronic gaming device programmed to merge, move, and multiply displayed Walking Wild symbols displayed thereon.

### DETAILED DESCRIPTION

Described herein are gaming systems, methods, and operations that include designated walking symbols (e.g., Walking Wild symbols) that become persistent for a period of game play when those designated symbols reach a designated location on a game matrix and aggregate when more than one designated walking symbol reaches a symbol location during the period of game play. In other words, during a bonus game, a player may be awarded a certain number of free spins that defines the period of game play for the bonus game. In some cases, additional free spins may be awarded during the bonus game to extend the bonus game and thus, extend the period of game play. In the example embodiment, during the bonus game, certain symbols, sometimes referred to as “Walking Wilds,” may be displayed on the game matrix. Once displayed, an award is provided based on the symbols displayed and a lookup within a pay table. On the next free spin of the bonus game, the designated symbols move or walk over to the next adjacent column (e.g., from right to left) and all other symbol positions respin, and then the game matrix is evaluated like before. This process continues until the walking symbols reach the first column where they remain (become persistent) for the remainder of the bonus game. In the example embodiment, if more than one Walking Wild symbols reach a single symbol position of the game matrix, the Walking Wild symbols will aggregate and will become a 2× Wild symbol or a 3× Wild symbol, etc.

For example, in electronic gaming devices including electronic gaming machines (EGMs), a credit value (or an award value) may be awarded to a player based, in part, upon credit symbols that land on or are displayed on reels in a game matrix area when the reels stop spinning during a base game and/or a bonus game (or a feature game). Generally, some game symbols are randomly (based on an output of a random number generator (RNG)) assigned a prize value and revealed as part of the game outcome. In some cases, the credit symbols that land in the game matrix are awarded to the player, for example, in a hold and spin game mechanic. One of the challenges that arises in game design is the desire to display higher value prizes during game play while also controlling game volatility. In other words, presenting or landing higher prize values during a game may result in the player receiving those higher prize values for a given game mechanic, which may in turn impact the overall volatility of the game and the ability to achieve a certain return to player (RTP). As a result, to achieve a designated game volatility and/or RTP, the game may be configured to present higher prize value to players at a relatively lower rate and lower prize values at a relatively higher rate. In addition, gaming devices that store multiple symbols having different values assigned to them for display purposes can require large amounts of memory and computation processing resources. It is desirous to have an EGM that is better able to control volatility while still frequently presenting large value awards and to do so using a gaming device that uses less memory and processing resources than convention machines.

The electronic gaming devices and operations described herein are configured to achieve a designated game volatility with an improved gaming device operation by moving certain symbols (e.g., Walking Wild symbols or Stacked Walking Wild symbols) that have landed on one or more symbol positions when the game reels stop spinning to an adjacent symbol position in an adjacent game reel (e.g., in an adjacent column) during the next free spin of the bonus game. By way of a non-limiting example, the Walking Wild symbol(s) may move from right to left to the next adjacent symbol position for the next free spin of the bonus game. In some embodiments, there may be several Walking Wild symbols that are stacked within a column that move or walk together to the next adjacent column for the next spin of the bonus game.

In the example embodiment, a game matrix area during a base game may be of m×n, where m represents a number of horizontal rows and n represents a number of vertical columns of symbol positions. By way of a non-limiting example, m may have a value of 10 and n may have a value of 5. Accordingly, the game matrix may have 50 game symbol positions. Additionally, or alternatively, each game symbol position may be a separate reel that spins upon receiving a wager or input from a game player, and a game symbol that is randomly selected using a random number generator (RNG) may land on one or more game symbol positions of the game matrix.

As described herein, in some embodiments of the bonus game, when a Walking Wild symbol lands on a game symbol position on the left most column (column 1) by moving each time during each spin or by landing in column 1 at the beginning of the bonus game, the Walking Wild symbol may be locked into that game symbol position on column 1 and remains there (e.g., becomes persistent) for the remaining number of free spins during the bonus game period. The Walking Wild symbol locked into the game symbol position on column 1 may be referenced herein as a locked or persistent Wild symbol. Accordingly, during any of the remaining free spins, if another Walking Wild symbol also moves into a game symbol position of one of the locked Wild symbols, then the award multiplier associated with the locked Wild symbol may be increased by 1. In other words, the award multiplier associated with the locked Wild symbol may be increased by a total number of Walking Wild symbols that walked or moved into that game symbol position on the left most column (or column 1) during the bonus game. The locked Wild symbols remain locked for the remaining spins of the bonus game play rather than exiting or dropping off the game matrix area. This feature allows for potentially larger awards as the award multipliers of Wild symbols may continue to increase as additional Walking Wild symbols walk onto previously locked Wild symbols. In other words, since the Walking Wild symbols do not leave from the game symbol positions (or reels) on the column 1 until the bonus game is complete, a multiplier associated with a locked Wild has the ability to grow as additional Walking Wild symbols move onto and aggregate on the same game symbol position of the locked Wild symbol on column 1.

In some embodiments, the Wild symbols include multiple different variations of wild symbols having different operations. For example, variations of Wild symbols may include a normal Wild symbol, a 2× Wild symbol, a 3× Wild symbol, and/or a Walking Wild symbol. In addition to the Wild symbols, other symbols (or non-special symbols) may include one or more picture symbols. During the bonus game, where the Walking Wild symbol moves to the adjacent symbol position in the next column when the new spin is triggered, the normal Wild symbol, the 2× Wild symbol, or the 3× Wild symbol does not move to the adjacent symbol position in the next column, and the symbol positions displaying the normal Wild, 2× Wild or 3× Wild symbol are re-spun when the new spin is triggered. Accordingly, the normal Wild symbol, the 2× Wild symbol, and the 3× Wild symbol may be also referred herein as a non-Walking Wild symbol.

As described herein, the Walking Wild symbol may move to the adjacent symbol position that is to the left of the current game symbol position of the Walking Wild symbol for the next spin of the bonus game, and thus the Walking Wild symbol persists on the game matrix during any spin of the bonus game. However, in certain example embodiments, the normal Wild symbol, the 2× Wild symbol, and/or the 3× Wild symbol do not persist once landed on a game symbol position. In other words, when any of these non-Walking Wild symbols are displayed on the game matrix during the bonus game, they remain on the game matrix for the one spin and then they spin off on the next spin and are replaced with whatever symbol lands on the next spin.

In some example embodiments of the bonus game, as the new spin is triggered, the Walking Wild symbol may move to the adjacent symbol position that is to the left of the current game symbol position of the Walking Wild symbol during the current spin of the bonus game play. When the new spin is triggered, the reel corresponding to the game symbol position in which the Walking Wild symbol has moved, does not spin. When reels stop spinning, any symbol including a 2× wild symbol, a 3× wild symbol, a Wild symbol, a Walking Wild symbol, or a non-special symbol may land in a game symbol position that is next to the game symbol position having the Walking Wild symbol in the same column.

However, when a Walking Wild symbol lands in a game symbol position that is next to the game symbol position having the Walking Wild symbol in the same column, the game symbol positions having Walking Wild symbols may merge to increase a portion of a stack having Walking Wild symbols. The merged game symbol positions having Walking Wild symbols may move to the adjacent symbol positions when the new spin is triggered during the bonus game unless the merged symbol positions are game symbol positions on column 1. In some embodiments, and by way of a non-limiting example, only Walking Wild symbols in game symbol positions on the same column may merge to have a taller stack of Walking Wild symbols that move together when the next spin is triggered, but a 2× Wild symbol or 3× Wild symbol landing next to the Walking Wild symbol in the same column may not merge with the Walking Wild symbol to have a taller stack of Walking Wild symbols. If more than one column has Walking Wild symbols in adjacent positions in the same column, then each column having Walking Wild symbols in adjacent positions may have Walking Wild symbols in the same column merged to have a taller stack of Walking Wild symbols in the respective column.

In some embodiments of the bonus game, movement of the Walking Wild symbols as described above may continue during each new spin causing the Walking Wild symbols in column 1 not being locked but rather appear to move to game symbol positions of column 5. In this example, column 5 is the right most column of the 10×5 game matrix. By way of a non-limiting example, when the Walking Wild symbols are moved from game symbol positions in column 1 to game symbol positions in column 5, all game symbol positions of column 5 may be populated with Walking Wild symbols.

In some embodiments, one or more Jackpot bonus symbols may land on one or more game symbol position when the reels stop spinning. By way of a non-limiting example, the Jackpot bonus symbol may also land on a game symbol position in which a locked or persistent Wild symbol or a Walking Wild symbol is present. When the Jackpot bonus symbol lands on the game symbol position in which the locked or persistent Wild symbol or the Walking Wild symbol is present, then that game symbol position may be evaluated as both the Jackpot bonus symbol and the locked or persistent Wild symbol or the Walking Wild symbol.

In some embodiments of the bonus game, when the Jackpot bonus symbol lands, a Jackpot bonus game may be triggered, and a game overlay including, for example, a single game reel or wheel showing a plurality of credit values and/or Jackpots (e.g., a Minor Jackpot, a Mini Jackpot, a Major Jackpot, and/or a Mega Jackpot) may be displayed. In some embodiments, the single game reel showing the plurality of credit values and/or Jackpots may substantially cover the display area of the electronic gaming device. Additionally, or alternatively, the Jackpot bonus game overlay may be reoriented horizontally for the Jackpot bonus game to be played.

In some embodiments, a Jackpot bonus symbol may land in a game symbol position on column 1 in which a locked or persistent Wild symbol is present. The Jackpot symbol in a game symbol position on column 1 underneath the locked or persistent Wild symbol may pop through the locked or persistent Wild symbol temporarily and repeatedly and may be evaluated as both the locked or persistent Wild symbol and the Jackpot symbol.

In some embodiments, the bonus game described herein may be triggered when base game symbols including free game stack symbols land on symbol positions within certain columns of the game matrix of 10×5. By way of a non-limiting example, the free game stack symbols may be a group of 3 free game symbols displayed on adjacent game symbol positions of a column. Accordingly, if at least some part of the group of 3 free game stack symbols (e.g., 1 free game stack symbol or 2 free game stack symbols) lands on game symbol positions within certain columns, the free game bonus feature may be triggered.

During the free game bonus feature, the free game stack symbols that triggered the bonus feature may be converted into the Walking Wild symbols and then move to the adjacent symbol position that is to the left of the current symbol position of the converted Walking Wild symbol before each spin of the free game bonus feature.

In some embodiments, the bonus game may be initiated with a designated number of free spins awarded to the player. By way of a non-limiting example, the designated number of free spins may be 10 or some other number. During a spin, a game symbol that awards a certain number of additional free spins may land in a game symbol position of any column. In some examples, the certain number of additional free spins awarded by the game symbol may be 1 additional free spin, 2 additional free spins, or 3 additional free spins, and so on.

In some embodiments, and by way of a non-limiting example, a Jackpot bonus symbol and a free game stack symbol may be prevented from landing on a symbol position during the same spin. The movement of Walking Wild symbols may occur automatically through a respin operation or when a spin input is received from the player to initiate the new spin.

In some embodiments, one or more game symbol positions where 2× Wild symbol and/or 3×Wild symbol may land when the reels stop spinning may be determined in accordance with a control logic. The control logic may be configured to prevent overlapping of the 2× Wild symbol and/or the 3× Wild symbol with the currently displayed Walking Wild symbols on the game matrix.

Accordingly, exemplary embodiments as described herein include Walking Wild symbols that may grow taller by merging adjacent Walking Wild symbols in the same column and then moving together to adjacent symbol positions in the adjacent column. Additionally, or alternatively, moving stacks of Walking Wild symbols and locking the stacks of Walking Wild symbols in column 1 provide persistence during the bonus game.

Additionally, in the exemplary embodiments of the bonus game, the electronic gaming device is configured to determine the symbols to display within the various symbol positions based at least in part upon a number of remaining free spins of the bonus game. By way of a non-limiting example, the gaming device is configured with multiple reel sets, and the reel set that is used for displaying symbols may be selected based on the number of remaining spins in the bonus game. For example, different reel sets may include different type of game symbols including, but not limited to, Walking Wild symbols, Multiplier Wild Symbols such as 2× Wild symbols and/or 3× Wild symbols, picture symbols, picture-1 symbols, picture-2 symbols, picture-3 symbols, picture-4 symbols, picture-5 symbols, Royals symbols, Suite symbols, A card symbols, K card symbols, Q card symbols, and/or J card symbols. As a result, the electronic gaming device is configured to better control game volatility and/or RTP by selecting the appropriate reels from the reel sets based on the number of free spins remaining within the bonus game. By utilizing different reels over the spins, the number of Walking Wild symbols (e.g., and indirectly the number of locked or persistent Wild Symbols) that are displayed are better spaced out over the number of the free spins so that the Walking Wild symbols are given an opportunity to be displayed at different locations on the game matrix at different times, and thus, allowing the walking of the symbols to be shown over the number of free spins. This feature provides greater variability to the game while still controlling RTP.

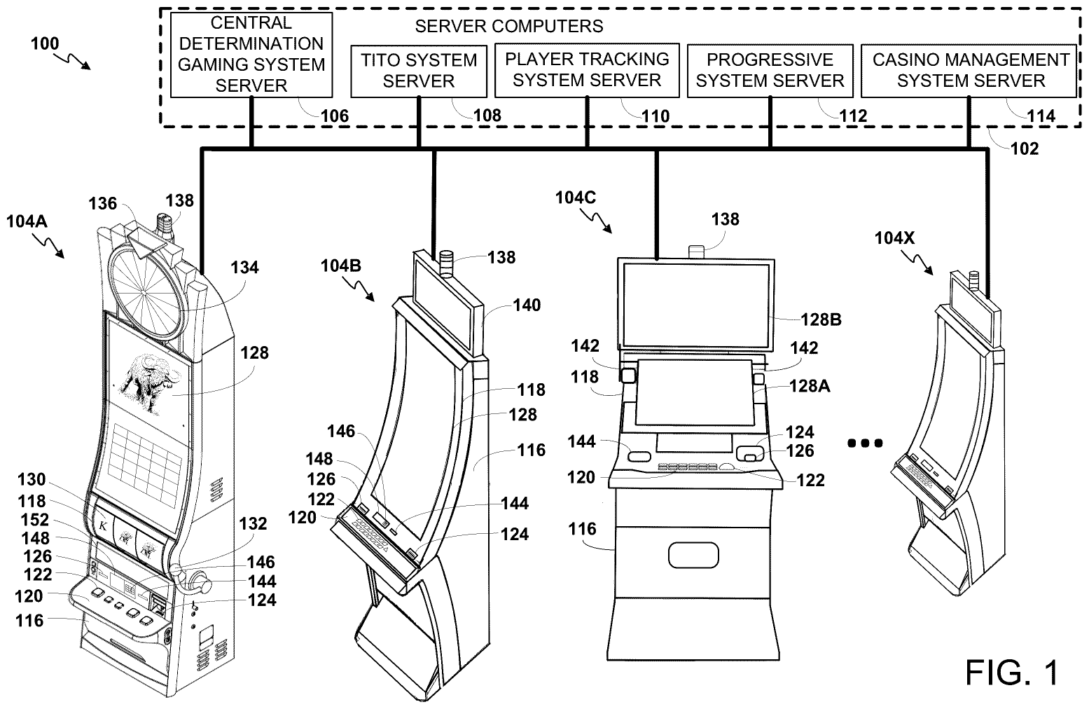

Various exemplary embodiments described herein are discussed below in more detail with respect to FIGS. 1, 2A-2C, 3, 4A-4L, and 5.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Realm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

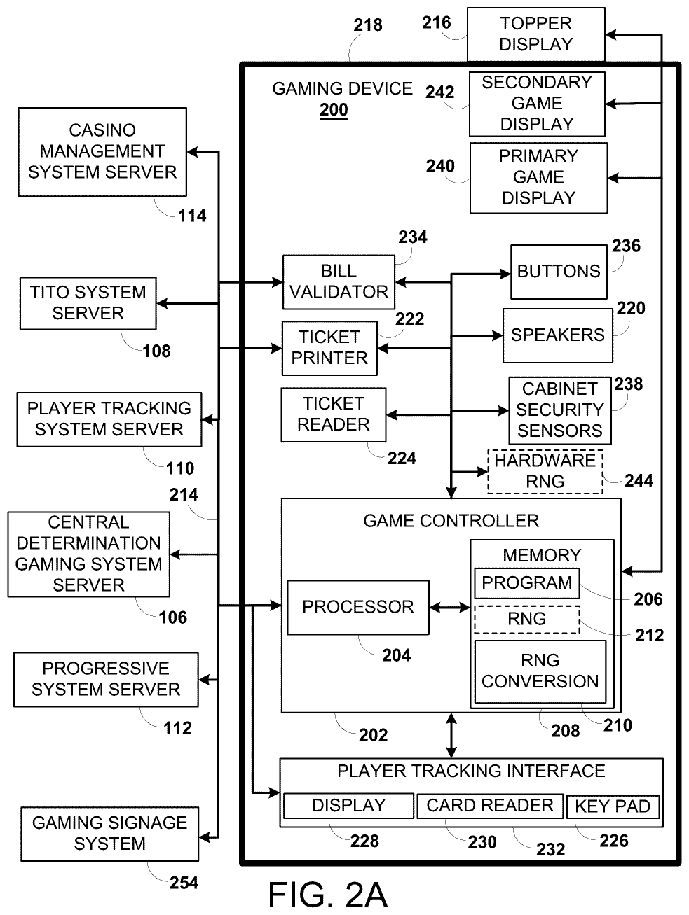

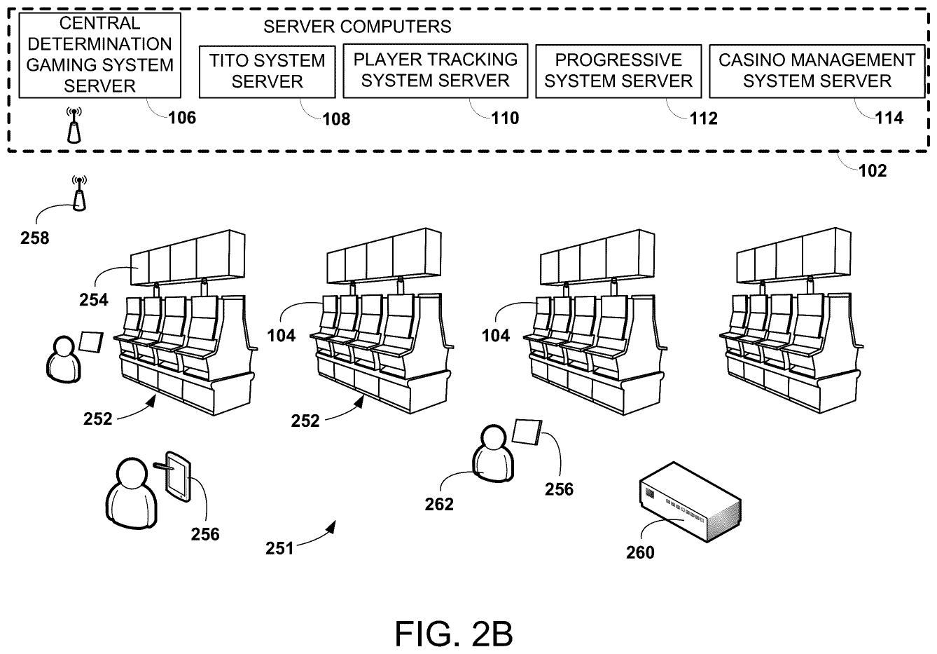

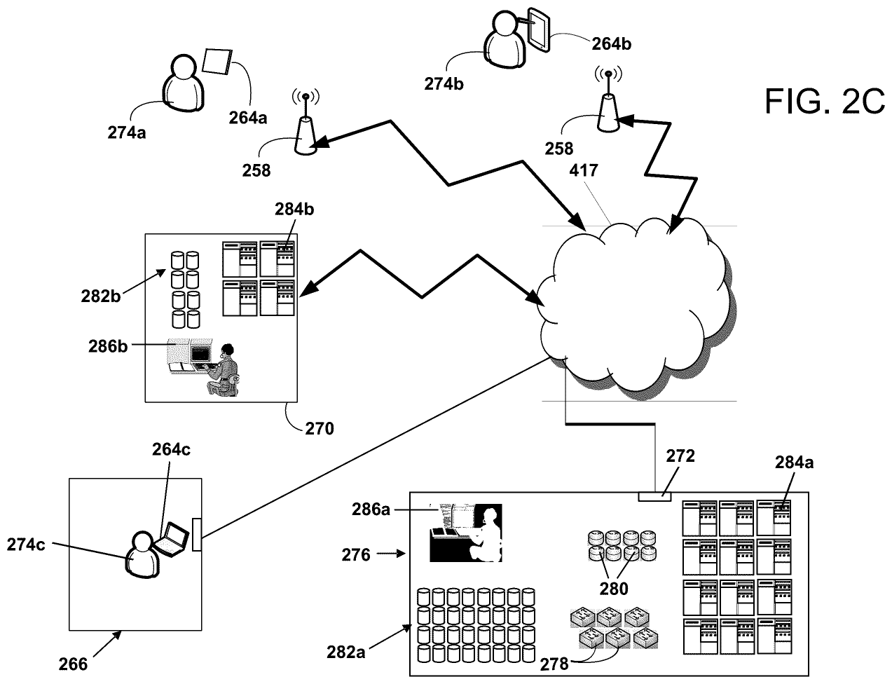

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

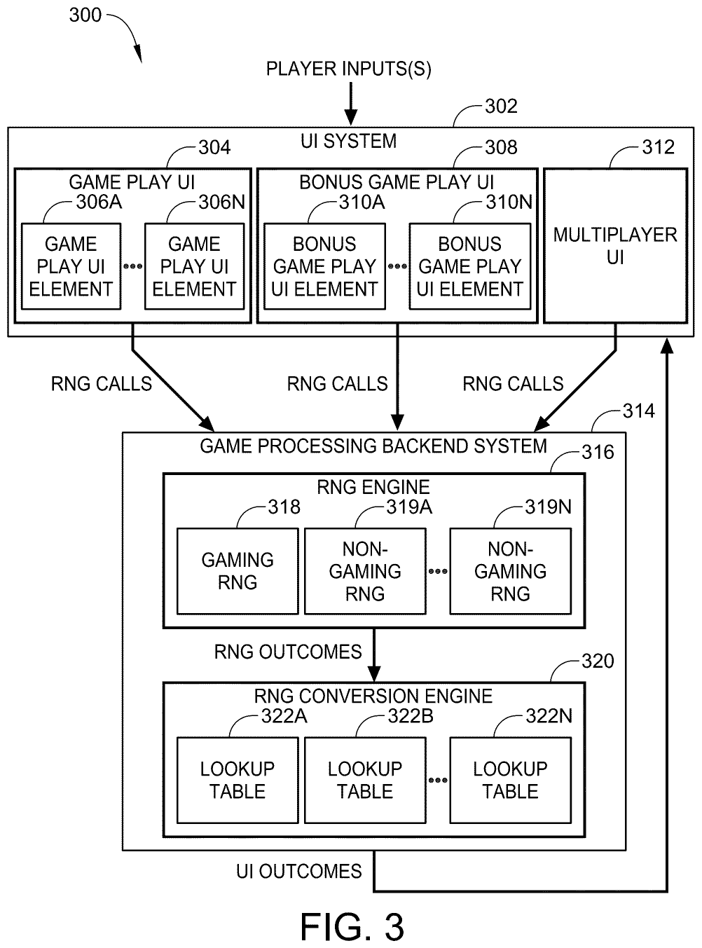

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

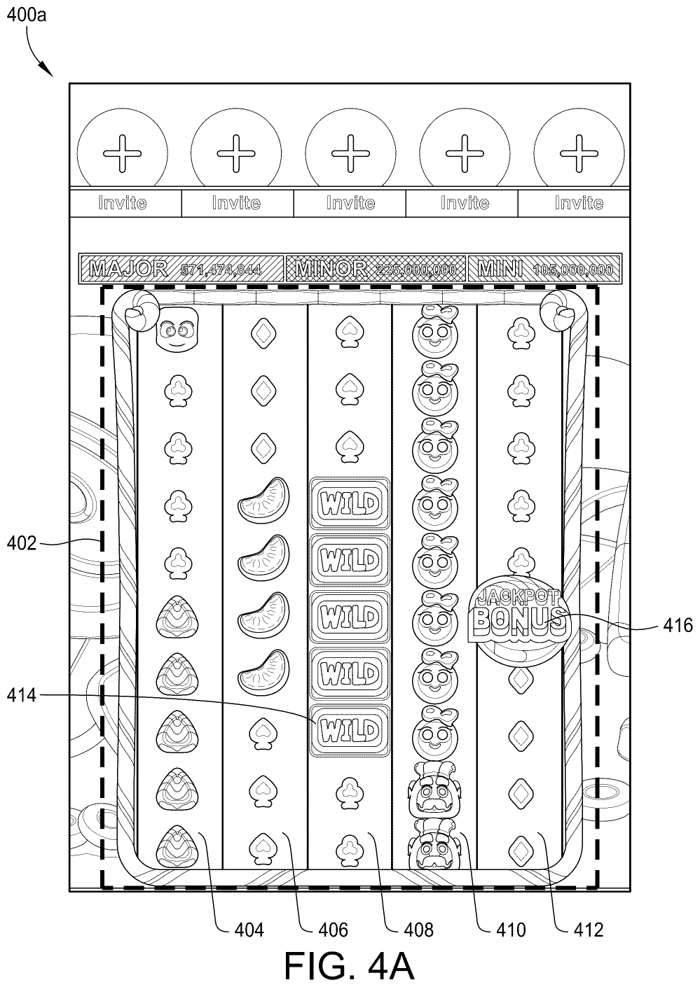

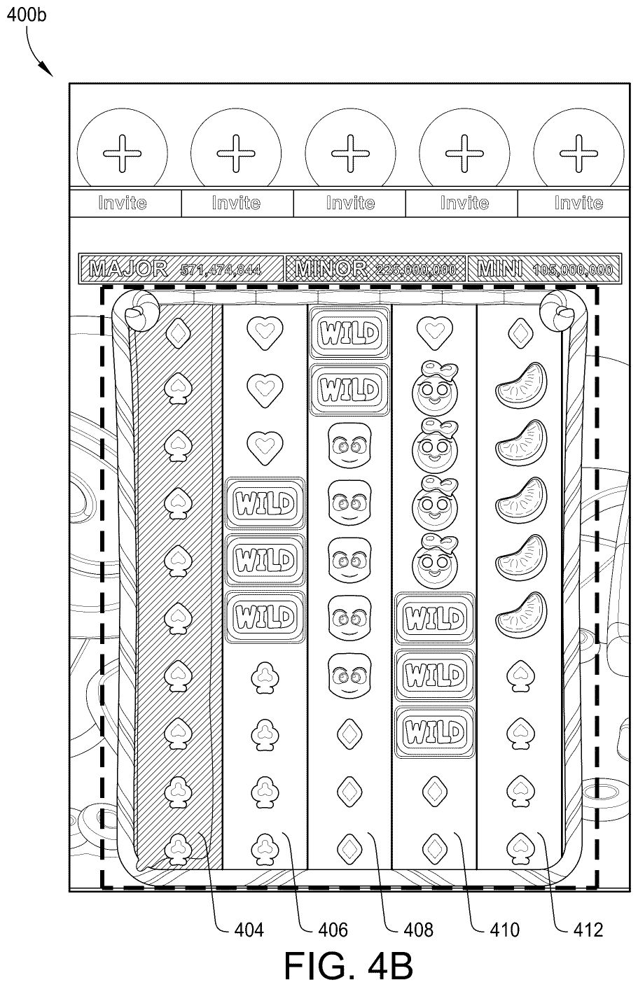

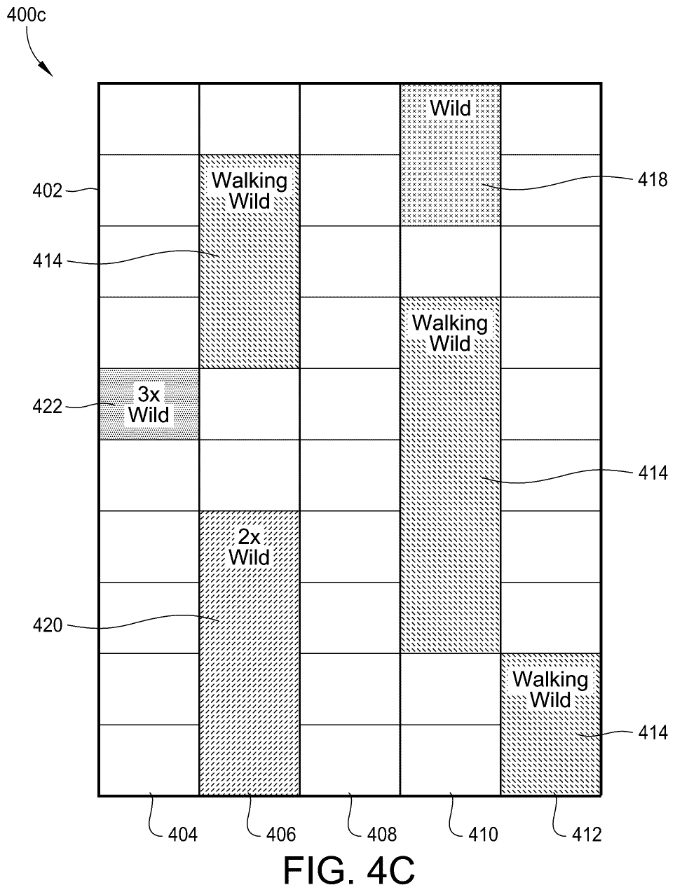

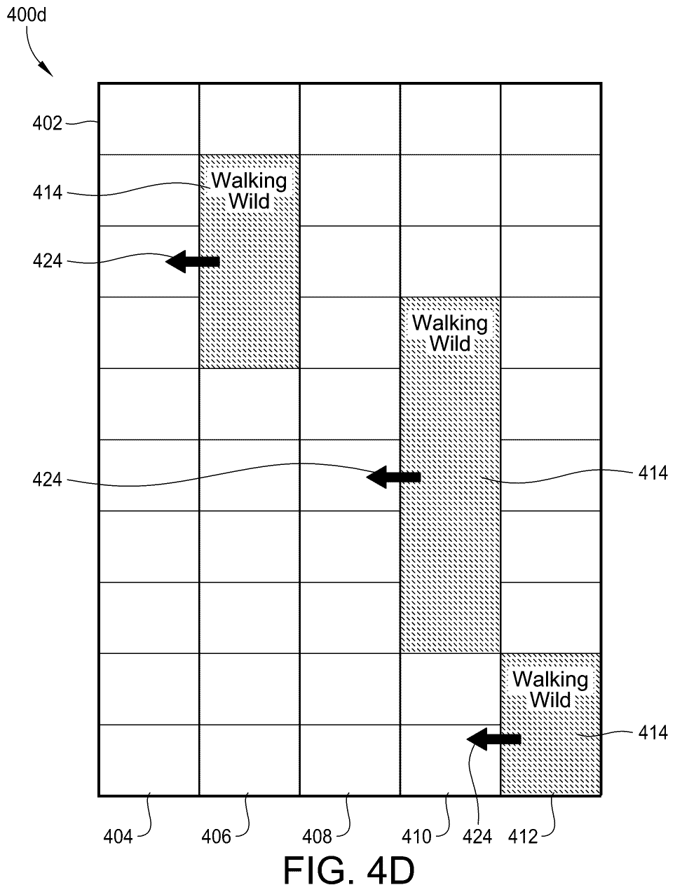

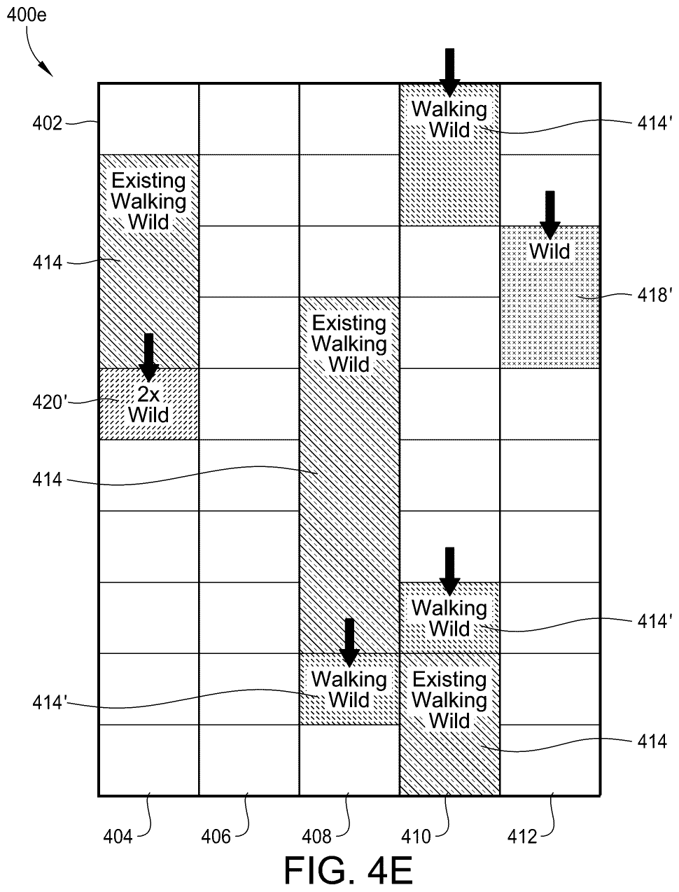

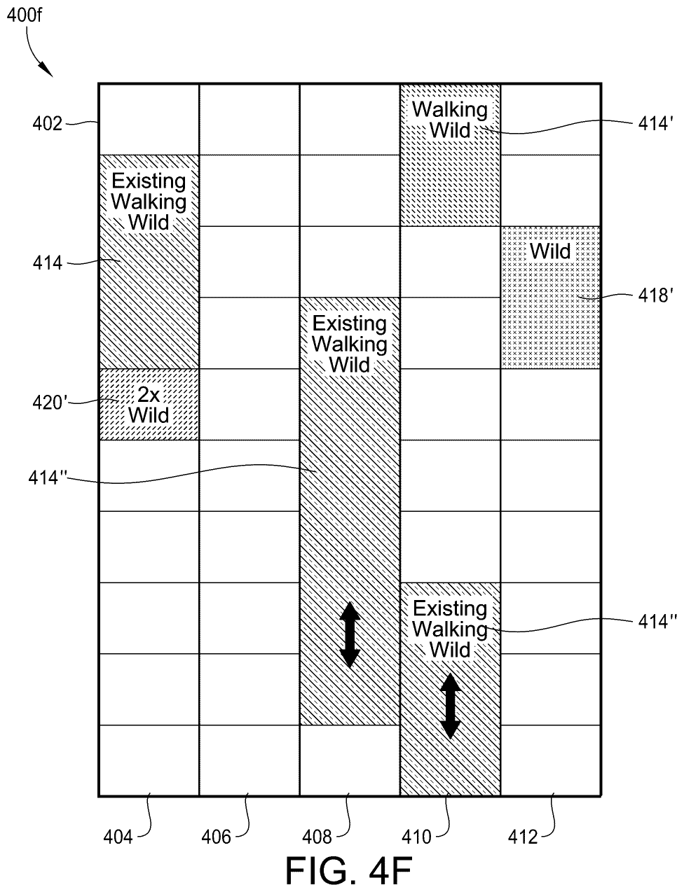

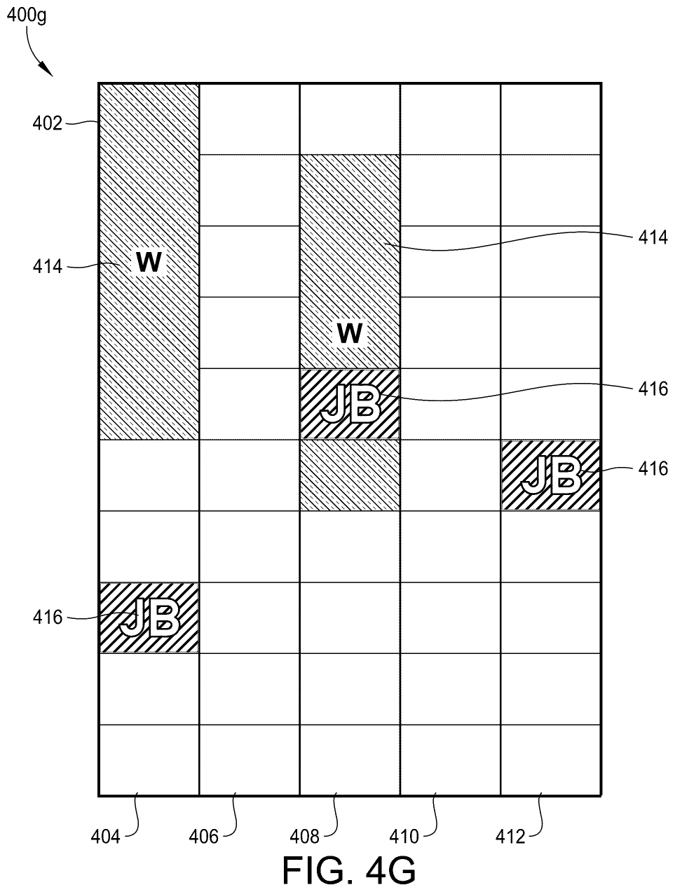

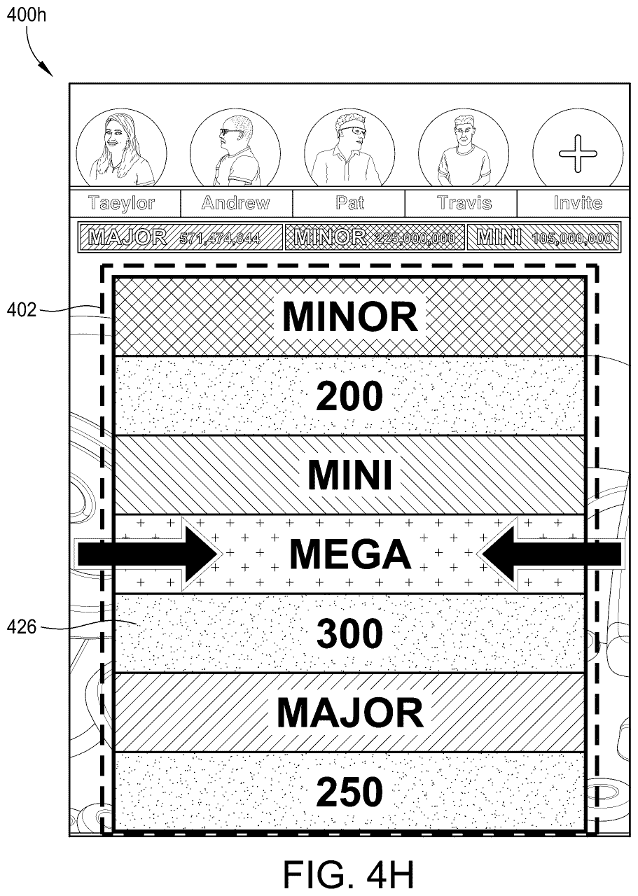

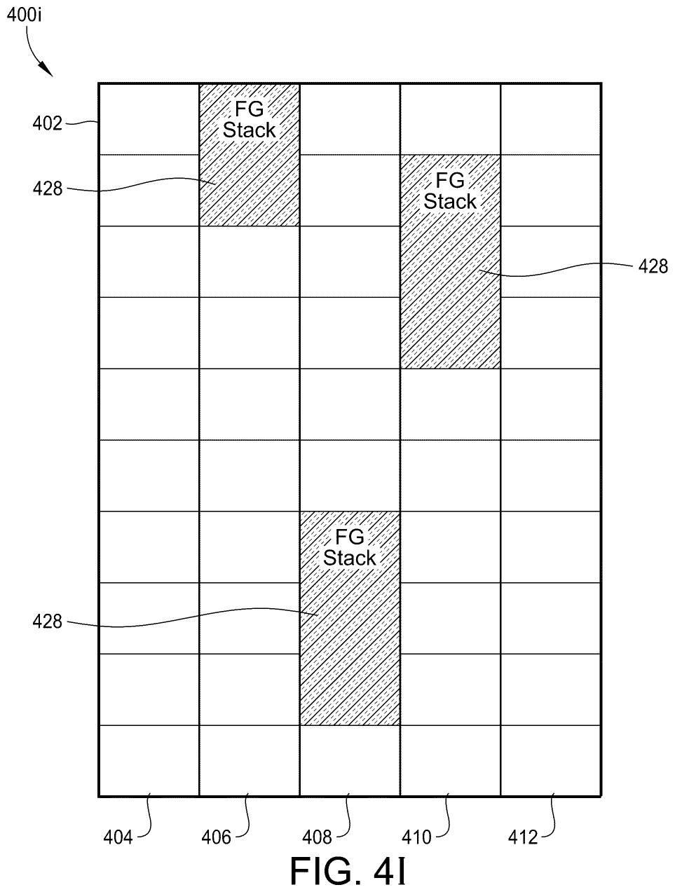

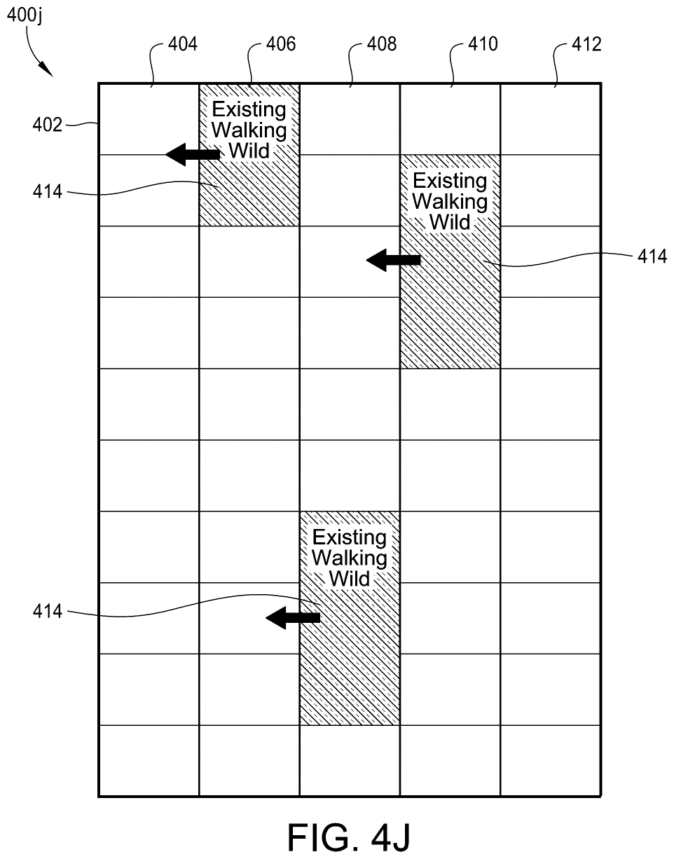

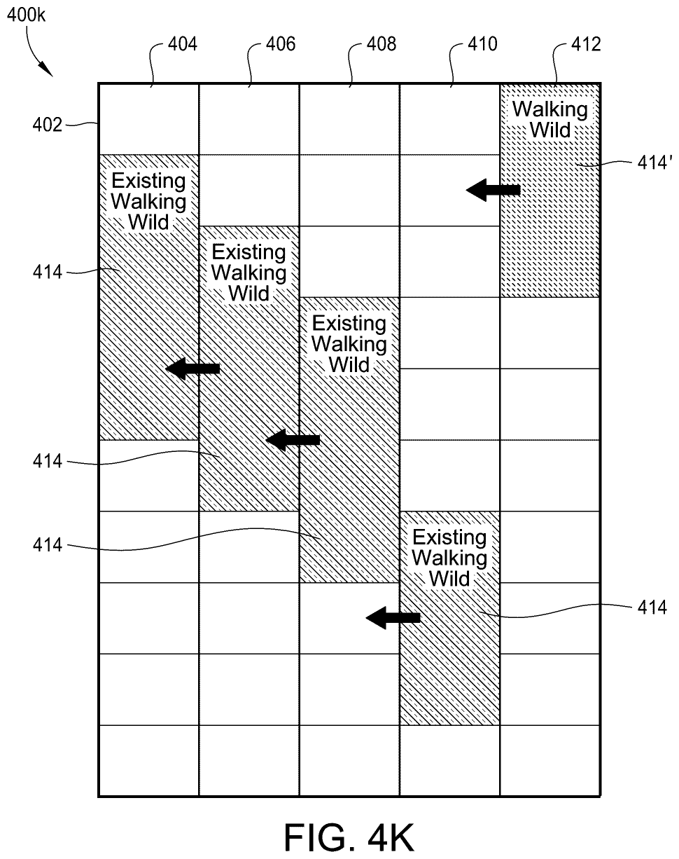

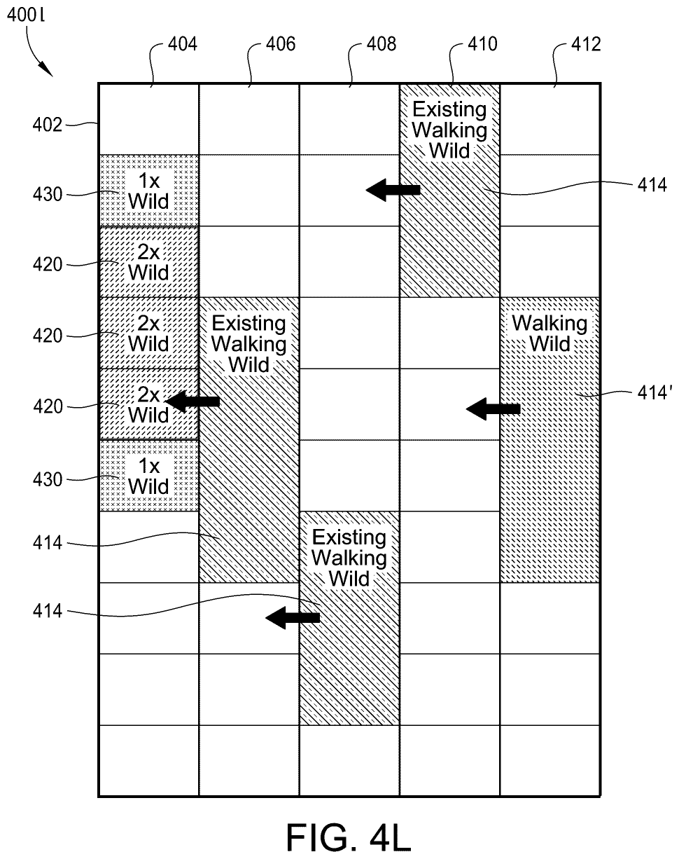

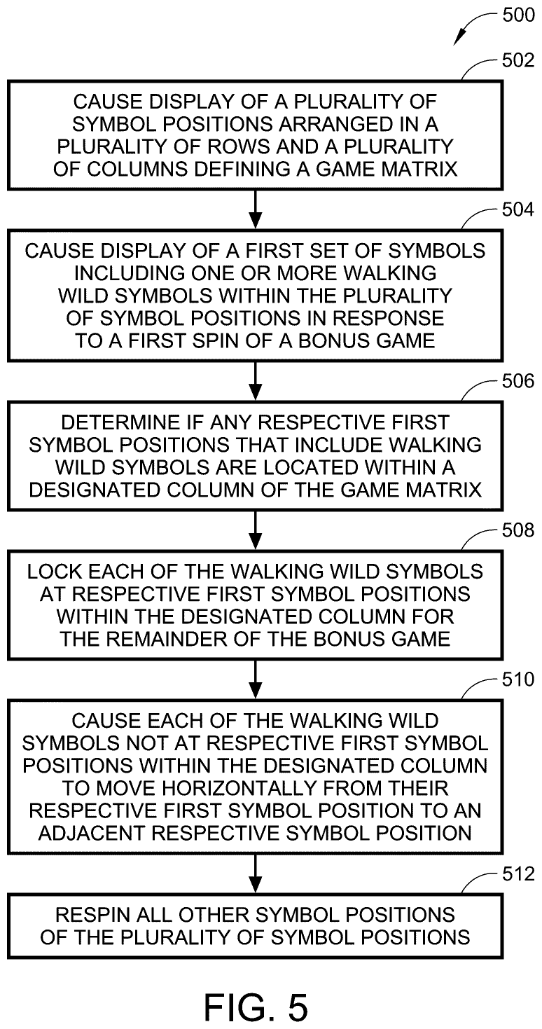

In some embodiments, the UI outcome of the UI system 302 during the base game, the Jackpot bonus game, and/or the free game may be according to exemplary embodiments described herein, which are discussed in more details with respect to FIGS. 4A-4L, and 5.

FIGS. 4A-4L are exemplary screenshots or user interfaces of an electronic gaming device programmed to (i) display and move designated persistence symbols (also referred to herein as “Walking symbols” or, in one embodiment “Walking Wild symbols”) during a base game, and then, after triggering a bonus game, (ii) display, merge, move, lock, and multiply Walking Wild symbols. In particular, FIGS. 4A-4L illustrate exemplary screenshots of a full or a partial view of an electronic gaming device during a base game, a bonus game, or a feature game, and/or transition between game instances. In an exemplary screenshot 400a, as shown in FIG. 4A, a game matrix area displayed on a display device of an electronic gaming device may include a plurality of reels as part of a base game. For example, the game matrix area 402 shown in FIG. 4A may be a 10 x 5 matrix, during a base game, which includes a plurality of reels arranged in 5 columns and 10 rows. Each column of the game matrix 402 may include a plurality of reels or a plurality of game symbol positions arranged in a plurality of rows. In the exemplary screenshot 400a, the game matrix 402 includes five columns, for example, column 1 404, column 2 406, column 3 408, column 4 410, and column 5 412. Upon receiving an input from a game player, one or more reels of one or more columns 404, 406, 408, 410 and/or 412 may start spinning, and when the one or more reels of the one or more columns 404, 406, 408, 410 and/or 412 stop spinning, various game symbols may land on the game symbol positions of the one or more columns.

In the exemplary screenshot 400a, a plurality of Wild symbols (or a plurality of stacked Walking Wild symbols) lands on the column 3 408 when the one or more reels stop spinning. A Wild symbol (or a Walking Wild symbol) is shown in the exemplary screenshot 400a as 414. A Jackpot symbol that lands in a game symbol position on column 5 412 is shown as 416. In the case of the base game, the Walking Wild symbols will move to the left next adjacent column for the next spin and will continue to move each spin until the Walking Wild symbols move off the matrix from column 1 404.

FIG. 4B is an exemplary screenshot 400b showing a similar game matrix as to what is shown in FIG. 4A, but showing the game in the bonus game mode. In the example embodiment, when in the bonus game mode, column 1 404 changes appearance indicating that any Walking Wild symbols that reach column 1 will become locked or persistent in position, and remain at that position within column 1 404 for the remainder of the bonus game. As discussed herein, when in the bonus game mode, certain operations are triggered (e.g., persistence in symbol position, etc.) that are not part of the base game mode.

In an exemplary screenshot 400c, as shown in FIG. 4C, a game matrix 402 at the end of a first spin during a bonus game may have stacked Walking Wild symbols 414 landed on a plurality of game symbol positions of column 2 406, column 4 410, and column 5 412 when the plurality of reels of column 1 404, column 2 406, column 3 408, column 4 410, and column 5 412 stop spinning. Additionally, or alternatively, one or more normal Wild symbols 418, one or more 2× Wild symbols 420, and one or more 3× Wild symbols 422 may land on one or more game symbol positions of the game matrix 402, and other symbols may land on the remaining game symbol positions. As described herein, the Wild symbol 418, the 2× Wild symbol 420, and the 3× Wild symbol 422 may be referenced herein as a non-Walking Wild symbol. An award value corresponding to a total number of Wild symbols 418, a total number 2× Wild symbols 420, a total number of 3× Wild symbols, and/or a total number of Walking Wild symbols 414 may be calculated, awarded, and displayed on a display of the electronic gaming device.

Upon receiving an input from the player, the next spin of the bonus game play may be initiated. In an exemplary screenshot 400d, as shown in FIG. 4D, during transition of the game matrix 402 for the next spin, the one or more Wild symbols 418, the one or more 2× Wild symbols 420, the one or more 3× Wild symbols 422, and the other symbols may be spun again on the game play matrix 402. The Walking Wild symbols 414 that landed on the game matrix 402 may move to the adjacent symbol position that is to the left of the current game symbol position of the Walking Wild symbol 414 as shown in the exemplary screenshot as 424. In some embodiments, the reels are displayed spinning beneath the persistent Walking Wild symbols 414, with the Walking Wild symbols 414 overlaid on the reels, such that underlying symbols on the reels may be displayed in the column to the player and evaluated for purposes of determining the game outcome. For example, in some embodiments, the Walking Wild symbol 414 may be displayed at least partially transparent to display an initial game outcome that includes symbols landing in positions that are overlaid by the Walking Wild symbol 414. In some such embodiments, after the initial outcome is evaluated, the Walking Wild symbol 414 may be displayed opaque, covering the underlying symbols on the reels, and are evaluated to determine a final game outcome.

Accordingly, as shown in the exemplary screenshot 400d, the Walking Wild symbol 414 persists on the matrix by moving over one column, for the period of the bonus game. When the plurality of reels stop spinning, the game symbols may land on the plurality of game symbol positions that are being spun again, for example, as shown in an exemplary screenshot 400e of FIG. 4E. Persistent Walking Wild symbols from the previous spin may move to symbol positions of column 1 404, column 3 408, and column 4 410 as shown in FIG. 4E as 414. New Walking Wild symbols, normal Wild symbols, and 2× Wild symbols that newly landed on a plurality of symbol positions when the reels stop spinning are shown in FIG. 4E as 414′, 418′, and 420′, respectively.

Persistent Walking Wild symbols 414 from the previous spin on column 3 408 may merge with the newly added adjacent Walking Wild symbols 414′ from the current spin on column 3 408 to have a taller stack of Walking Wild symbols 414, which is shown in an exemplary screenshot 400f of FIG. 4F as 414″. Similarly, persistent Walking Wild symbols 414 from the previous spin on column 4 410 may merge with the newly added adjacent Walking Wild symbols 414′ from the current spin on column 4 410 to have a taller stack of Walking Wild symbols 414, which is shown in an exemplary screenshot 400f of FIG. 4F as 414″. While the Walking Wild symbols on column 3 408 and on column 4 410 may move to column 2 406 and column 3 408, respectively, when the new spin is initiated, Walking Wild symbols 414 on column 1 404 may become locked or persistent Wild symbols, and may not leave from game symbol positions on column 1 404 until the bonus game is ended.

In FIG. 4F, a concept of merging Walking Wild symbols to generate a taller stack of Walking Wild symbols is illustrated. Walking Wild symbols in game symbol positions on column 1 404, also referenced herein as locked or persistent Wild symbols, may increase or multiply based on a number of Walking Wild symbols that move into a game symbol position of column 1 404 when a new spin is initiated.

In an exemplary screenshot 400g of FIG. 4G, in some embodiments of the bonus game, one or more Jackpot bonus symbols 416 may land on one or more game symbol positions of the game matrix 402 when the reels stop spinning. By way of a non-limiting example, the Jackpot bonus symbol 416 may also land on a game symbol position that is a locked or persistent Wild symbol position on column 1 404 or a Walking Wild symbol position on any of column 2 406, column 3 408, column 4 408 and/or column 5 410. When the Jackpot bonus symbol 416 lands on the game symbol position that is the locked or persistent Wild symbol position or the Walking Wild symbol position, then that game symbol position may be evaluated as both the Jackpot bonus symbol and the locked or persistent Wild symbol or the Walking Wild symbol.

In some embodiments, when the Jackpot bonus symbols lands, a Jackpot bonus game may be triggered, and a game overlay 426, as shown in an exemplary screenshot 400h of FIG. 4H, may be displayed. The game overlay 426 may display, for example, a single game reel or wheel showing a plurality of credit values and/or Jackpots (e.g., a Minor Jackpot, a Mini Jackpot, a Major Jackpot, and/or a Mega Jackpot). In some embodiments, the single game reel showing the plurality of credit values and/or Jackpots may substantially cover a display area of a display of the electronic gaming device. In some embodiments, the game overlay 426 may be reoriented and shown horizontally instead of vertically during the Jackpot bonus game.

In some embodiments, a Jackpot bonus symbol may land in a symbol position on column 1 in which a locked or persistent Walking Wild symbol is present. The Jackpot symbol in a symbol position on column 1 underneath the locked or persistent Walking Wild symbol may pop through the locked or persistent Walking Wild symbol temporarily and repeatedly and may be evaluated as both the locked or persistent Wild symbol and the Jackpot symbol.

FIG. 4i illustrates an exemplary screenshot 400i of the base game that corresponds to the triggering of a bonus game. As shown in the exemplary screenshot 400i, game symbols including free game stack symbols 428 may land on symbol positions within certain columns. For example, in the exemplary screenshot 400i, free game stack symbols 428 are displayed as being landed in symbol positions within column 2 406, column 3 408, and/or column 4 410. By way of a non-limiting example, the free game stack symbols 428 may be a group of 3 free game stack symbols displayed in adjacent symbol positions in the same column. Accordingly, if at least some part of the group of 3 free game stack symbols (e.g., 1 free game stack symbol or 2 free game stack symbols) lands on symbol positions within certain columns, for example, on symbol positions within each of column 2 406, column 3 408, and column 4 410, the bonus game may be triggered, and the player may receive a designated number of free spins, for example, 10 free spins or another number of free spins. Additionally, during the bonus game, the player may receive additional number of free spins as described herein.

During the free game bonus feature, the free game stack symbols 428 that triggered the free game bonus feature may be converted into the Walking Wild symbols 414 as shown in an exemplary screenshot 400j of FIG. 4J, and may move to symbol positions in the adjacent left column before each new spin of the bonus game. Walking Wild symbols that landed in symbol positions during the base game and prior to the beginning of bonus game, e.g., when the bonus game is triggered, may not become part of the bonus game, although, in some embodiments, Walking Wild symbols that land in symbol positions during the base game and prior to the beginning of the bonus game may become part of the bonus game.

Exemplary screenshots 400k and 400l of FIG. 4K and FIG. 4L, respectively, describe a variant of the bonus game. In this variant of the bonus game, when the reels stop spinning, Walking Wild symbols 414′ may land on symbol positions within each column except column 1 of the game matrix. As described herein, before the next spin is initiated, the Walking Wild symbols 414′ may move to symbol positions in adjacent left column. If the adjacent left column is column 1 with a Walking Wild symbol present in a symbol position within column 1, an award multiplier value corresponding to the Walking Wild symbol in a symbol position within column 1 may be increased in accordance with a number of Walking Wild symbols moving into the symbol position within column 1, as shown in the exemplary screenshot 400l.

Referring back to FIG. 4A, in the exemplary embodiment, the symbols populating the matrix 402 are determined based on reels associated with each of the columns 404-412. In particular, the memory stores one or more reel sets, with each reel in the reel set corresponding to at least one of the columns 404-412. In an example embodiment, a reel set may include one reel for each one of the columns (i.e., five reels in total), and the symbols populated in the column are selected by selecting stopping positions of the reels using an RNG output, and optionally, weightings.

In the exemplary embodiment, memory 208 stores a plurality of reel set groups, including the reel sets, and the reel sets are selected to determine spin outcome. In other embodiments, one or more of the reel sets may be stored in any suitable storage medium described herein. Different reel sets are used for play of the base game as compared with the free game.

In some embodiments, during play of the base game, the reels used for the game may be selected based on at least one of a number and/or position of the Walking Wild symbols that are currently persisting on the columns. The reel sets used for a subsequent spin of the base game may be selected by grouping the reel sets into groups of reel sets that are predetermined to control the RTP based on the current state of Walking Wild symbols. In some embodiments, a table is stored (e.g., on memory 208) that identifies a weight for each occurrence of a Walking Wild symbol on the columns. For example, a Walking Wild symbol occurring in the second column may have a greater cost (in terms of “RTP”) relative to a Walking Wild in the fifth column, as it is more likely to form a winning payline in the second column when the outcome is evaluated. Accordingly, the table may include a first column identifying the column number and a second column identifying the weight. For example, the first (i.e., leftmost) column may have a weight of zero, the second column may have a weight of five, the third column may have a weight of three, and the fourth and fifth columns may each have weights less than third column. For each occurrence of the Walking Wild symbols, weights may be assigned based on a lookup of the table and each of the weights for the Walking Wild symbols are added to produce a total weight output in the form of a single number. As an example, in FIG. 4A, where five Walking Wild symbols are shown in column 3, the total weight output is fifteen (i.e., five times 3).

In the exemplary embodiment, the reel set used for the base game is selected by selecting one of the reel set groups based on the total weight output. Each reel set group (or reel set tier) is associated with a range of total weight output values in a table. A lookup of the table is performed using the total weight output to identify the reel set group that is used to generate the outcome of the subsequent spin. In one embodiment, the table includes a first column identifying each of the reel set groups and a second column identifying a range of total weight outputs. For example, a first group may be associated with a total weight output range of 0 to 20, a second group may be associated with a total weight output range of 20 to 40, etc. In the example of 4A, the first group would be selected based on the total weight output of 15 falling within the range of 0 to 20. The reel set used for the subsequent spin is then selected from the first group, such as by performing a randomized lookup of a weighted table.

During play of the bonus game, as shown in FIG. 4B, one or more reel sets are selected for use based on a state of the feature game, such as a number of free spins remaining. The plurality of reel set groups may each include reel sets that are grouped together in a tier and which are used based on a different number of remaining free games. In one example, the memory stores a lookup table that includes a column identifying a predetermined range of free spins remaining and a column identifying one or more of the reel set groups. For example, a first number of free spins remaining (e.g., 6 or more free spins) may be associated with a first reel set group, a second number of free spins remaining (e.g., 5) may be associated with a second reel set group, etc. The reel set for use during a spin of the free spins game is selected by first selecting one of the reel set groups based on a lookup of the table using the number of free spins remaining. Each of the reel set groups include one or more reel sets and the reel set is further selected by performing a random lookup of a weighted table identifying each reel set within the selected reel set group.

In some embodiments, the reel sets are each grouped based on probabilities of certain events, such as Walking Wild symbols, occurring in the game play outcome. For example, one or more of the reel sets used when there are fewer spins remaining (e.g., 2) may include a greater number of Walking Wild symbols, as compared to the reel sets of other groups used when there are more (e.g., 5 spins remaining), thereby improving control over return-to-player (“RTP”) and reducing the probability of outlier outcomes, such as where a large amount of multiplier walking wilds persist in the first column for several rounds of the bonus game.

FIG. 5 illustrates an exemplary flow-chart 500 of method operations performed by an electronic gaming device (e.g., an EGM) programmed to merge, move, and increment any award multipliers associated with Walking Wild symbols displayed thereon. The electronic gaming device may include a display device. In some examples, the electronic gaming device may include an interface device coupling the electronic gaming device with an electronic gaming server. The electronic gaming device may also include a memory device that is configured to store instructions, which may be executed by a game controller of the electronic gaming device. The game controller may include a processor that is configured to execute the instructions stored in the memory device and/or instructions received from the electronic gaming server. One or more instructions received from the electronic gaming server and/or executed by the electronic gaming device may be generated using at least one RNG. By way of a non-limiting example, the electronic gaming device may be a user equipment device such as a smartphone, a tablet, a laptop, a smart glass, and so on.

The electronic gaming device may receive an amount of a bet wagered by a player on the electronic gaming device. The bet wagered by the player on the electronic gaming device may be cash, tokens, and/or credits, and so on. The bet may be wagered by the player in other forms as well. In response to the received amount of bet or wager, and in response to the user input to begin game play, a game controller may cause display (502) of a plurality of symbol positions arranged in a plurality of columns and a plurality of rows defining a game matrix. By way of a non-limiting example, the game matrix may be a 10×5 matrix in which the plurality of columns may include 5 columns and the plurality of rows may include 10 rows as shown in FIG. 4A-FIG. 4L. Each symbol position of the plurality of symbol positions may be a reel that spins upon receiving a wager or an input from a game player and when the reel stops spinning, a game symbol may land on the symbol position.

The method operations may include, in response to a first spin of a bonus game and using a first output from a random number generator (RNG), the game controller to cause display (504) of a first set of symbols. The first set of symbols is displayed within the plurality of symbol positions. The first set of symbols includes one or more Walking Wild symbols. Each of the one or more Walking Wild symbols may be displayed in respective first symbol positions.

The method operations may include, in response to a second spin of the bonus game, causing the game controller to determine (506) if any respective first symbol positions that include Walking Wild symbols are located within a designated column of the game matrix. By way of a non-limiting example, the designated column may be a first column. The first column may be the leftmost column of the game matrix.

The method operations may include causing the game controller to lock (508) each of the Walking Wild symbols at respective first symbol positions within the designated column for the remainder of the bonus game upon determining that Walking Wild symbols are present in one or more first symbol positions located in the designated column of the game matrix.

Upon determining that Walking Wild symbols are not present in one or more first symbol positions located in the designated column of the game matrix, the game controller may cause each of the Walking Wild symbols not at those respective first symbol positions within the designated column to move (510) horizontally from their respective first symbol position to an adjacent respective second symbol position. Additionally, or alternatively, each of the Walking Wild symbols in the respective first symbol positions that are adjacent in a non-designated column may be merged and the merged Walking Wild symbols may be horizontally moved together from their respective first symbol position to the adjacent respective second symbol position.

As described herein, the horizontal move of each of the Walking Wild symbols not at those respective first symbol positions within the designated column may be in a right-to-left direction. Further, an award multiplier value corresponding to each of the Walking Wild symbols at those respective first symbol positions within the designated column may be increased, e.g. incremented or multiplied when another Walking Wild symbol is moved into any of those respective first symbol positions within the designated column. In other words, an award multiplier value corresponding to a locked Walking Wild symbol may be updated from nX to (n+1) X when another Walking Wild symbol lands in a position of the locked Walking Wild symbol, where n is a current award multiplier value corresponding the locked Walking Wild symbol that is represented as X and a value of n is 1, 2, or 3.

The method operations may include causing the game controller to respin (512) all other symbol positions of the plurality of symbol positions.

In some embodiments, the first set of symbols may further include one or more wild symbols, one or more 2× wild symbols, one or more 3× wild symbols, one or more Jackpot symbols, or non-special symbols. Additionally, or alternatively, displaying of the one or more 2× wild symbols or the one or more 3× wild symbols may be controlled to not overlap with any Walking Wild symbol in a symbol position in any column of the plurality of columns from previous spins. By way of a non-limiting example, each reel corresponding to a game symbol position may have a corresponding set of symbols selected based on different weights assigned to the set of symbols.

Accordingly, various embodiments, as described herein, may provide improvement over known EGMs as stacks of Walking Wild symbols grow taller when merged together and are moved to game symbol positions in adjacent columns of the game matrix to provide persistence during the bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a memory device storing instructions; and
a processor configured to execute the instructions stored in the memory device, which, when executed, cause the processor to:
cause display of a plurality of symbol positions arranged in a plurality of columns and a plurality of rows defining a game matrix;
cause display, for a first spin of a bonus game, of a first set of symbols each within the plurality of symbol positions including a first designated persistence symbol displayed in a first symbol position of a first column of the plurality of columns and a second designated persistence symbol displayed in a first symbol position of a second column of the plurality of columns;
in response to the first designated persistence symbol being displayed in the first column, lock the first designated persistence symbol in the first symbol position of the first column for at least one or more subsequent spins of the bonus game; and
in response to the second designated persistence symbol being displayed in the second column, move the second designated persistence symbol horizontally from the second column to an adjacent column of the plurality of columns for a second spin of the bonus game.

2. The electronic gaming system of claim 1, wherein the first column is a designated column of the matrix for play of the bonus game, and wherein any designated persistence symbols occurring in the first column are locked in position in the first column for subsequent spins of the bonus game.

3. The electronic gaming system of claim 1, wherein the instructions further cause the processor to:
cause display, for the first spin, of a third designated persistence symbol in a second symbol position of the second column, the second symbol position of the second column being vertically adjacent to the first symbol position of the second column; and
merge the second designated persistence symbol and the third designated persistence symbol to form a merged designated persistence symbol, wherein moving the second designated persistence symbol includes moving the merged designated persistence symbol.

4. The electronic gaming system of claim 1, wherein the move of the second designated persistence symbol horizontally from the second column to the adjacent column is in a right-to-left direction.

5. The electronic gaming system of claim 1, wherein the first column is the leftmost column of the game matrix.

6. The electronic gaming system of claim 1, wherein the instructions, when executed by the processor, further cause the processor to:
cause display, for a first spin of a base game, of an additional set of symbols, the set of symbols including one or more free game symbols; and
trigger the bonus game in response to the one or more free game symbols occurring within a set of predetermined columns.

7. The electronic gaming system of claim 6, wherein the set of predetermined columns includes at least 3 columns.

8. The electronic gaming system of claim 6, wherein the instructions further cause the processor to, before initiating the first spin of the free games bonus game, convert the one or more free games symbols into designated persistence symbols and move the converted designated persistence symbols horizontally from their respective symbol positions into adjacent symbol positions to the left of the symbol positions.

9. The electronic gaming system of claim 1, wherein the instructions, when executed by the processor, further cause the processor to:
store a table identifying a plurality of reel set groups, each reel set group of the plurality of reel set groups including a plurality of reel sets for populating the symbol positions of the matrix;
identify a number of free spins remaining for the bonus game;
select a first group from the plurality of reel set groups based on the number of free spins remaining for the bonus game; and
select a first reel set from the first group based on a randomized lookup of a weighted table associated with the first group, wherein the first set of symbols are displayed within the plurality of symbol positions using the first reel set.

10. The electronic gaming system of claim 9, wherein each of the plurality of reel sets of each reel set group includes a plurality of reels having symbols thereon, each of the reels being associated with one of the columns of the plurality of columns.

11. A non-transitory computer-readable storage medium with instructions stored thereon that, in response to execution by at least one processor, cause the at least one processor to:
cause display of a plurality of symbol positions arranged in a plurality of columns and a plurality of rows defining a game matrix;
cause display, for a first spin of a bonus game, of a first set of symbols each within the plurality of symbol positions including a first designated persistence symbol displayed in a first symbol position of a first column of the plurality of columns and a second designated persistence symbol displayed in a first symbol position of a second column of the plurality of columns;
in response to the first designated persistence symbol being displayed in the first column, lock the first designated persistence symbol in the first symbol position of the first column for at least one or more subsequent spins of the bonus game; and
in response to the second designated persistence symbol being displayed in the second column, move the second designated persistence symbol horizontally from the second column to an adjacent column of the plurality of columns for a second spin of the bonus game.

12. The non-transitory computer-readable medium of claim 11, wherein the first column is a designated column of the matrix for play of the bonus game, and wherein any designated persistence symbols occurring in the first column are locked in position in the first column for subsequent spins of the bonus game.

13. The non-transitory computer-readable medium of claim 11, wherein the instructions further cause the at least one processor to:
cause display, for the first spin, of a third designated persistence symbol in a second symbol position of the second column, the second symbol position of the second column being vertically adjacent to the first symbol position of the second column; and
merge the second designated persistence symbol and the third designated persistence symbol to form a merged designated persistence symbol, wherein moving the second designated persistence symbol includes moving the merged designated persistence symbol.

14. The non-transitory computer-readable medium of claim 11, wherein the instructions further cause the at least one processor to:
store a table identifying a plurality of reel set groups, each reel set group of the plurality of reel set groups including a plurality of reel sets for populating the symbol positions of the matrix;
identify a number of free spins remaining for the bonus game;
select a first group from the plurality of reel set groups based on the number of free spins remaining for the bonus game; and
select a first reel set from the first group based on a randomized lookup of a weighted table associated with the first group, wherein the first set of symbols are displayed within the plurality of symbol positions using the first reel set.

15. The non-transitory computer-readable medium of claim 14, wherein each of the plurality of reel sets of each reel set group includes a plurality of reels having symbols thereon, each of the reels being associated with one of the columns of the plurality of columns.

16. An electronic gaming device comprising:
a display device;
a memory device storing instructions; and
a game controller comprising a processor configured to execute the instructions stored in the memory device, which, when executed, cause the game controller to:
cause the display device to display a plurality of symbol positions arranged in a plurality of columns and a plurality of rows defining a game matrix;
cause the display device to display, for a first spin of a bonus game, a first set of symbols each within the plurality of symbol positions including a first designated persistence symbol displayed in a first symbol position of a first column of the plurality of columns and a second designated persistence symbol displayed in a first symbol position of a second column of the plurality of columns;
in response to the first designated persistence symbol being displayed in the first column, lock the first designated persistence symbol in the first symbol position of the first column for at least one or more subsequent spins of the bonus game; and
in response to the second designated persistence symbol being displayed in the second column, move the second designated persistence symbol horizontally on the display device from the second column to an adjacent column of the plurality of columns for a second spin of the bonus game.

17. The electronic gaming device of claim 16, wherein the first column is a designated column of the matrix for play of the bonus game, and wherein any designated persistence symbols occurring in the first column are locked in position in the first column for subsequent spins of the bonus game.

18. The electronic gaming device of claim 16, wherein the instructions further cause the game controller to:
cause display, for the first spin, of a third designated persistence symbol in a second symbol position of the second column, the second symbol position of the second column being vertically adjacent to the first symbol position of the second column; and
merge the second designated persistence symbol and the third designated persistence symbol to form a merged designated persistence symbol, wherein moving the second designated persistence symbol includes moving the merged designated persistence symbol.

19. The electronic gaming device of claim 16, wherein the instructions further cause the game controller to:
store a table identifying a plurality of reel set groups, each reel set group of the plurality of reel set groups including a plurality of reel sets for populating the symbol positions of the matrix;
identify a number of free spins remaining for the bonus game;
select a first group from the plurality of reel set groups based on the number of free spins remaining for the bonus game; and
select a first reel set from the first group based on a randomized lookup of a weighted table associated with the first group, wherein the first set of symbols are displayed within the plurality of symbol positions using the first reel set.

20. The electronic gaming device of claim 19, wherein each of the plurality of reel sets of each reel set group includes a plurality of reels having symbols thereon, each of the reels being associated with one of the columns of the plurality of columns.
